(19) United States
(12) Patent Application Publication
(10) Pub. No.: US 2025/0131509 A1
(43) Pub. Date: Apr. 24, 2025

(54) SEQUENTIAL EVENT RISK PREDICTION

(71) Applicant: NEC Laboratories America, Inc., Princeton, NJ (US)

(72) Inventors: LuAn Tang, Cranbury, NJ (US); Peng Yuan, Princeton, NJ (US); Haifeng Chen, West Windsor, NJ (US)

(21) Appl. No.: 18/619,851

(22) Filed: Mar. 28, 2024

Related U.S. Application Data
(60) Provisional application No. 63/591,540, filed on Oct. 19, 2023.

(51) Int. Cl. G06Q 40/08

(52) U.S. Cl. CPC G06Q 40/08

(57) ABSTRACT

Systems and methods for event prediction include converting event information into categorical time series data for a plurality of properties; determining relationships between pairs of properties of the plurality of properties based on a plurality of data types. A likelihood of an event occurring is predicted during a future period by summing over a Hawkes process for the pairs of properties, the Hawkes process taking as input the relationships between the pairs of properties and comparing the likelihood to an anomaly threshold that is based on a range of normal intensity values for transition sets based on the categorical time series data; and performing an action responsive to a determination that the likelihood exceeds the anomaly threshold.

### RELATED APPLICATION INFORMATION

This application claims priority to U.S. Patent Application No. 63/591,540, filed on Oct. 19, 2023, incorporated herein by reference in its entirety.

This application is related to U.S. Patent Applications (Attorney Docket Number 23153MX and 23159MX) filed concurrently herewith.

### BACKGROUND

### Technical Field

The present invention relates to anomaly prediction and risk assessment, and more particularly, evaluating and predicting risk in systems with a large number of sensors or components.

### Description of the Related Art

A Cyber-Physical System (CPS) is characterized by the deployment of a large number of sensors tasked with the surveillance of the system's operational status. Within the realm of CPS maintenance and operation, anomaly monitoring and detection is an important task. Nonetheless, the endeavor of anomaly detection in CPS applications confronts two major challenges: First, a considerable proportion of sensors in CPS environments convey categorical data not numerical measurements. Second, a substantial subset of anomalies manifests as event sequences of intricate interdependencies among multiple sensors, rather than being predicated upon the time series of individual ones.

Unfortunately, most existing anomaly detection methods are designed exclusively for the analysis of numerical sensor data, thereby rendering them incapable of modeling intricate relationships among categorical sensors. Consequently, their practical utility for real-time CPS monitoring tasks remains constrained.

Current risk assessment techniques can suffer from incomplete information due to lack of sensor data making their predictions inaccurate. In industries related to random or seemingly random events, e.g., natural disasters, stock prices, etc., a more complete set of information is needed to assess risk.

### SUMMARY

According to an aspect of the present invention, a computer-implemented method for event prediction includes converting event information into categorical time series data for a plurality of properties; determining relationships between pairs of properties of the plurality of properties based on a plurality of data types; predicting a likelihood of an event occurring during a future period by summing over a Hawkes process for the pairs of properties, the Hawkes process taking as input the relationships between the pairs of properties; comparing the likelihood to an anomaly threshold that is based on a range of normal intensity values for transition sets based on the categorical time series data; and performing an action responsive to a determination that the likelihood exceeds the anomaly threshold.

In other embodiments, converting the event information into categorical time series data can include mapping numerical values onto categorical values. De-noising the categorical time series data can be performed by determining a mean duration and standard deviation for an initial state of each transition set to calculate the coefficient of variation and removing transition sets with a coefficient of variation that is above a threshold value. The plurality of data types can include a relationship value based on a correlation of categorical time series data for a pair of properties. The plurality of data types can further include a grid distance between locations associated with the pair of properties. The plurality of data types can further include a road network distance between locations associated with the pair of properties. The correlation of categorical time series data can be determined for the pair of properties using a neural network model. The correlation of categorical time series data can be determined for the pair of nodes based on an occurrence of events in the time series data within a threshold time. The anomaly can relate to a likelihood of a natural disaster occurring at a particular location, such that a likelihood output of the Hawkes process that exceeds the anomaly indicates that the natural disaster is likely to occur at the location. The action can include adjusting an insurance premium associated with a property of the plurality of properties in accordance with the anomaly.

In other embodiments, a computer program product for event modeling can be employed. The computer program product includes a computer readable storage medium having program instructions embodied therewith, the program instructions executable by a hardware processor to cause the hardware processor to perform the methods described herein.

According to an aspect of the present invention, a system for event prediction includes a hardware processor and a memory that stores a computer processor which, when executed by the hardware processor, causes the hardware processor to convert event information into categorical time series data for a plurality of properties; determine relationships between pairs of properties of the plurality of properties based on a plurality of data types; predict a likelihood of an event occurring during a future period by summing over a Hawkes process for the pairs of properties, the Hawkes process taking as input the relationships between the pairs of properties; compare the likelihood to an anomaly threshold that is based on a range of normal intensity values for transition sets based on the categorical time series data; and perform an action responsive to a determination that the likelihood exceeds the anomaly threshold.

In other embodiments, the computer program can further cause the hardware processor to map numerical values onto categorical values. The computer program can further cause the hardware processor to de-noise the categorical time series data by determining a mean duration and standard deviation for an initial state of each transition set to calculate the coefficient of variation and removing transition sets with a coefficient of variation that is above a threshold value. The plurality of data types can include a relationship value based on a correlation of categorical time series data for a pair of properties. The plurality of data types can further include a grid distance between locations associated with the pair of properties. The plurality of data types can further include a road network distance between locations associated with the pair of properties.

The computer program can further cause the hardware processor to determine the correlation of categorical time series data for the pair of properties using a neural network model. The computer program can further cause the hardware processor to determine the correlation of categorical time series data for the pair of nodes based on an occurrence of events in the time series data within a threshold time. The anomaly can relate to a likelihood of a natural disaster occurring at a particular location, such that a likelihood output of the Hawkes process that exceeds the anomaly indicates that the natural disaster is likely to occur at the location, and wherein the computer program further causes the hardware processor to adjust an insurance premium associated with a property of the plurality of properties in accordance with the anomaly.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for maintenance and risk assessment in the context of a monitored system, in accordance with an embodiment of the present invention;

FIG. 2 shows time series diagrams of sensor data for monitored events, in accordance with an embodiment of the present invention;

FIG. 3 is a block/flow diagram illustrating a set of categorical time series from a monitored system, in accordance with an embodiment of the present invention;

FIG. 4 a block/flow diagram showing details on denoising sensor data, in accordance with an embodiment of the present invention;

FIG. 5 is a block/flow diagram showing details on grouping transition sets according to their frequencies, in accordance with an embodiment of the present invention;

FIG. 6 is a block/flow diagram showing details on building sensor relationship graph models and evaluating normal relationship ranges, in accordance with an embodiment of the present invention;

FIG. 7 is a block/flow diagram showing details on setting an anomaly threshold, in accordance with an embodiment of the present invention;

FIG. 8 is a block/flow diagram showing a Multivariate Hawkes Process based Insurance Estimation (MHPIE) tool to estimate insurance premiums based on sequential event modeling, in accordance with an embodiment of the present invention;

FIG. 9 shows an event time series diagram for a given house, in accordance with an embodiment of the present invention;

FIG. 10 is a block diagram showing a method for combining different data types, in accordance with an embodiment of the present invention;

FIG. 11 shows an example map depicting a route that shows a distance between two real properties, in accordance with an embodiment of the present invention;

FIG. 12 shows a satellite map having a generated grid and depicting a relationship between two real properties, in accordance with an embodiment of the present invention;

FIG. 13 shows a block diagram for an exemplary processing system, in accordance with an embodiment of the present invention; and

FIG. 14 shows a block/flow diagram depicting a dynamic system/method, which constantly updates a model in accordance with new and updated event or occurrence information, in accordance with an embodiment of the present invention.

### DETAILED DESCRIPTION OF PREFERRED EMBODIMENTS

In accordance with embodiments of the present invention, a tool to monitor and evaluate sequential events is described. In an embodiment, health of a cyber-physical system (CPS) can be monitored, based on categorical sensor relationships and sequential events. A multivariate Hawkes process-based categorical anomaly detection (MHPCAD) tool can enable the use of categorical data as well as numerical data to realize improved modeling and risk assessment. MHPCAD obtains a sensor relationship graph from historical normal data. MHPCAD trains the sequential event model based on the Hawkes process, automatically determining the normal score range and anomaly thresholds. MHPCAD can train the model offline and then apply the model on live streaming data for efficient online detection.

MHPCAD contributes to the efficient and effective management of CPS by MHPCAD which needs a limited parameter setting in advance (e.g., by a default setting), which can be applied to a wide variety of CPS. A sensor relationship graph model of MHPCAD can be employed to both detect anomalies and illustrate the anomalies in a visualized way to an end user. The MHPCAD uses normal data as training input, and does not need any anomalies to train the model. This makes normal sensor data much easier to collect in real CPS applications.

In other embodiments, a Multivariate Hawkes Process based Insurance Estimation (MHPIE) tool can be employed that integrates multi-modality data such as historical records, satellite images, and property-specific historical data to construct relationship graphs. By employing a sequential event model based on the Hawkes process, MHPIE autonomously identifies and evaluates risk factors associated with natural disasters and other occurrences. Moreover, the MHPIE tool offers seamless policy updates for all properties in response to new events, ensuring adaptability and effectiveness in risk management strategies.

Embodiments described herein can address problems by analyzing sequential events among multiple categorical sensors. This enables, e.g., a CPS monitoring system to cover more categorical sensors with better detection sensitivity. While some of the present embodiments are described in the context of a CPS, it should be understood that they may be applied to any type of system that includes both categorical data and numerical data.

In an embodiment, a CPS monitoring system can include a risk assessment system. Risk assessment systems can be employed for predicted known but random or seemingly random events. In one embodiment, a risk assessment system can be employed to determine the likelihood of a hurricane, the likelihood of hurricane landfall at a particular location, etc. In other systems, the risk assessment system can be employed to determine a failure mode in an automobile, whether a manufactured part will fail inspection, etc. In still other systems, the risk assessment system can be employed to predict future adverse health events for a patient.

In an example application, a risk assessment system can model the likelihood of a flood at a particular location. Relevant data for modeling can include numerical and categorical variables from sources such as flood maps, building construction types, height above sea-level, sea-level rising factors, rainfall, etc. Combining different types of data into a single model, for example, satellite photographs combined with internet of things (IoT) sensors could provide local information to make locally specific predictions of risk for insurance purposes or other applications feasible and practical.

The methods and systems of the present invention can be adapted for predicting risk in local regions using data from a number of sources and data types. For example, image data from satellites and numerical sensor data can be combined so that the different types of information can be used in a single model. Historic insurance data can potentially be transformed into sensor-like data and employ Hawkes processing in accordance with embodiments of the present invention. Premium computations, risk assessments, the occurrence of rare events, anomaly detection and other relevant applications can be conducted based upon a more complete data set and therefore provide a better prediction model(s).

Embodiments of the present invention can be employed to generate accurate alerts on categorical sensor data and help end users understand the anomalies. The systems and methods can work on the categorical sensor readings, whereas most state-of-the-art anomaly detection methods work only on numerical sensor readings. The numerical sensors can be easily transformed to categorical sensors by pre-processing technologies such as z-score normalization. While difficult, categorical readings can also be transformed into numerical data.

In particularly useful embodiments, the systems and methods can generate a graph model based on event relationships and changes/transitions of sensor values. This graph model can be used to detect abnormal events and to illustrate the process of such events for anomaly diagnosis. Normal data may be employed as training input, so that data explicitly showing anomalies is not needed for training. This makes it easier to create training data, as anomalous events are rare in comparison to normal operations. The systems and methods can be applied to a large variety of applications with categorical data, e.g., automobile, air quality monitoring system, power plants, vehicles, satellites, insurance, etc.

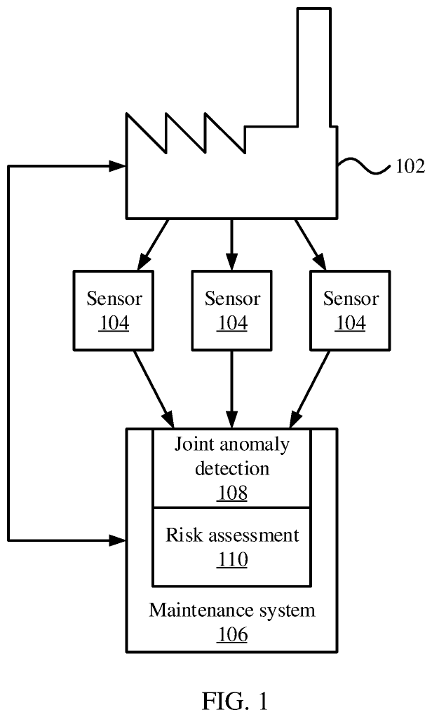

Referring now in detail to the figures in which like numerals represent the same or similar elements and initially to FIG. 1, a maintenance system 106 and risk assessment 108 in the context of a monitored system 102 is shown. The monitored system 102 can be any appropriate system, including physical systems such as manufacturing lines and physical plant operations, electronic systems such as computers or other computerized devices, software systems such as operating systems and applications, and cyber-physical systems that combine physical systems with electronic systems and/or software systems. Exemplary systems 102 may include a wide range of different types, including railroad systems, power plants, vehicle sensors, data centers, satellites, and transportation systems. Another type of cyber-physical system can be a network of internet of things (IoT) devices, which may include a wide variety of different types of devices, with various respective functions and sensor types.

One or more sensors 104 record information about the state of the monitored system 102. The sensors 104 can be any appropriate type of sensor including, for example, physical sensors, such as temperature, humidity, vibration, pressure, voltage, current, magnetic field, electrical field, light sensors, software sensors, such as logging utilities installed on a computer system to record information regarding the state and behavior of the operating system and applications running on the computer system. The sensor data may include, e.g., numerical data and categorical or binary-valued data. The sensor data may be stored as log information that records the occurrence of discrete events. The information generated by the sensors 104 can be in any appropriate format and can include sensor log information generated with heterogeneous formats.

In addition, the monitored system 102 may be an organic or geological system. For example, the monitored system 102 may be a human patient in a healthcare facility or livestock in an agricultural setting. In such examples, the sensors 104 may collect vital signs from the patient, such as heart rate, blood oxygen saturation, blood sugar, etc. Examples of categorical information that may be measured for an organic system include whether the subject is conscious or unconscious and whether the subject is physically active or is sedentary. The sensors 104 may collect vehicle status, speeding, braking habits, traffic conditions, etc.

In other examples, the monitored system 102 may be environmental, including geological, hydrological, or meteorological systems, such as a particular watershed, tectonic fault line, or weather system. Sensors 104 in such embodiments may monitor real-time information about the system, such as precipitation, humidity, and seismological activity. Categorical information for such systems may include, e.g., whether it is raining, the season, and features of the fault.

The sensors 104 may transmit the logged sensor information to a maintenance system 106 by any appropriate communications medium and protocol, including wireless and wired communications. The maintenance system 106 can, for example, identify abnormal or anomalous behavior by monitoring the multivariate time series and log information that are generated by the sensors 104. Once anomalous behavior has been detected, the maintenance system 106 communicates with a system control unit to alter one or more parameters of the monitored system 102 to correct the anomalous behavior.

Exemplary corrective actions include changing a security setting for an application or hardware component, changing an operational parameter of an application or hardware component (for example, an operating speed), halting and/or restarting an application, halting and/or rebooting a hardware component, changing an environmental condition, changing a network interface's status or settings, etc. The maintenance system 106 thereby automatically corrects, alerts of or mitigates the anomalous behavior. By identifying the particular sensors 104 that are associated with the anomalous classification, the amount of time needed to isolate a problem can be decreased.

In the context of an organic system, the corrective action may include the automatic adjustment of a treatment for a patient. For example, the maintenance system 106 may trigger the administration of medication or the cessation of a particularly harmful procedure. In the context of an environmental system, the corrective action may be to issue evacuation warnings in advance of a significant weather or seismological event.

Each of the sensors 104 may output a respective time series, which encodes measurements made by the sensor over time. The sensor data may be numerical or categorical in nature. For example, the time series may include pairs of information, with each pair including a measurement and a timestamp, representing the time at which the measurement was made. Each time series may be divided into segments, which represent measurements made by the sensor over a particular time range. Time series segments may represent any appropriate interval, such as one second, one minute, one hour, or one day. Time series segments may represent a set number of collection time points, rather than a fixed period of time, for example covering 100 measurements. Whereas numerical data may be represented as a number value, such as an integer or floating point value, the categorical information may be encoded as an indication that the system is one of a predetermined number of states. The multivariate time series may include information relating to the occurrence of different types of event (e.g., represented by the outputs of different sensors 104) across a shared timeline.

The maintenance system 106 therefore includes a model that may be trained to handle numerical data and categorical data. For a complicated system 102, the number of sensors 104 may be very large, with the sensors reporting independent streams of time-series data.

The maintenance system 106 may further include risk assessment 110. Risk assessment 110 looks to the future behavior of the monitored system 102 to determine whether an anomaly is likely to occur. For example, certain conditions indicated by the sensor data may indicate that an anomaly will occur in the near or far future. In the case of an environmental system, this may indicate that a given location is likely to suffer damage from seismological or meteorological events, such as an earthquake or hurricane. In the case of an organic system, this may indicate that a patient is predisposed to a heart attack or certain types of cancer.

Anomaly detection and risk assessment 108 may make use of MHPCAD to handle categorical sensor data. Numerical data may be translated to categorical data for use by MHPCAD, thereby fusing both types of data for analysis. A graph model may be used based on event relationships and changes or transitions in sensor values. The graph model may detect and predict abnormal events and may illustrate the process of such events.

Training of an anomaly detection/prediction model may be performed on a set of historical data, which may include categorical data and numerical data that is taken during normal operation of a system. The data from categorical sensors may use different values to represent their respective operational states, and it can be challenging to identify relationships between such sensors based solely on their respective categorical values.

Further, the historical sensor data may include noise, which may exhibit dynamic and irregular variations in the durations of unique values. Additionally, there may be a large number of events, such as categorical value changes, in a given sensor's output over time. The computational complexity for handling N such events may be O(N²). As N may be very large, due to the number of different sensors and the potentially long duration of the historical data time series, computational efficiency can be a significant challenge.

Thus, the historical data may be pre-processed to improve the efficiency and effectiveness of the system. In particular, noisy data within the historical sensor data may be identified on a per-transition type basis, and data associated with transitions that are found to be noisy may be removed from the historical data. This produces input data which is less noisy and more compact. As a result, the computational burden of handling the smaller input dataset is correspondingly lowered, while the results are improved due to the reduction in noise. Thus the functioning of a computer system that operates on any such input data is improved in both its effectiveness and efficiency.

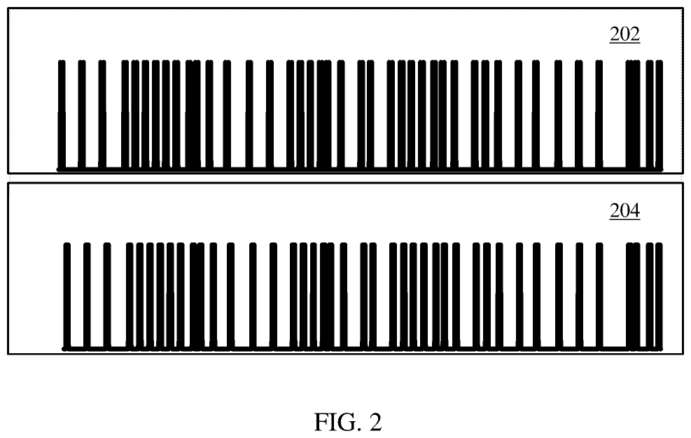

Referring now to FIG. 2, a set of categorical time series from a monitored system 102 are shown. Transition sets may be used to model complexity in the categorical sensor data. The output of two sensors is shown, including a first sensor output 202 and a second sensor output 204. Both sensors have only two unique values (e.g., binary valued outputs). The sensors' values change at similar times, indicating that they likely have a temporal relationship.

Transition data can therefore be generated for each sensor's data. MHPCAD generates a transition library for each categorical sensor. Points where the sensor value changes may be interpreted as transition points. Information can be tracked regarding the source value and target value of a transition. Using this transition library for each set of categorical sensor data, MHPCAD may group the transitions of each sensor into different sets. Each transition point in the transition sets includes two elements: transition type and the time of the transition.

The sensor data may include noise, which may exhibit dynamic and irregular variations in the durations of unique values. Additionally, there may be a large number of events, such as categorical value changes, in a given sensor's output over time. The computational complexity for handling N such events may be O(N²). As N may be very large, due to the number of different sensors and the potentially long duration of the historical data time series, computational efficiency can be a significant challenge.

Noisy data may be removed from the sensor outputs. Noise in categorical sensors may be dynamic and irregular in duration. For example, in a binary-valued sensor output, transitions from 0 to 1 may be regular and predictable, whereas the duration for which the system stays in the 1 state may be dynamic and irregular. Using the transition source value, transitions originating from the value 1 can be eliminated in this example, as they contribute to the noise of the data. Noisy data can have unpredictable effects in determining the likelihood of an anomaly, and so removal of the noisy data improves the accuracy of predictions.

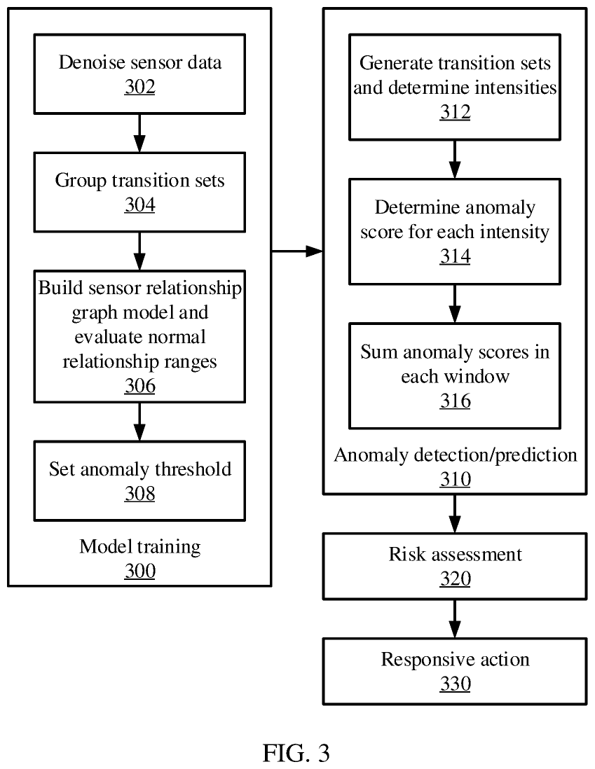

Referring now to FIG. 3, a method for training and using an anomaly detection/prediction model is shown. Model training 300 is performed on a set of historical data, which may include categorical data and numerical data that is taken during normal operation of a system. The data from categorical sensors may use different values to represent their respective operational states, and it can be challenging to identify relationships between such sensors based solely on their respective categorical values.

Some sensors may generate numerical data, and some sensors may generate categorical data. Numerical data can be converted to categorical data by, e.g., identifying a range of values and setting ranges that define categories. Thus, for a range of values that varies between 1 and 100, the values may be binned in ranges of ten, such that any value between 1 and 10 is assigned to category 1, any value between 11 and 20 is assigned to category 2, and so on. Any other appropriate process for converting numerical data to categorical data may be used instead.

Block 302 removes noise from the sensor data, as noted above and as will be described in greater detail below. Block 304 then groups transition sets according to frequency to reduce temporal complexity. With N as the total number of events (e.g., categorical value transitions) from the sensors 104, the number N can be very large due to the number of sensors and monitoring time. The events can therefore be partitioned into groups according to their frequencies. If there are m groups with average size n, then N=mn. The relationships are retrieved for events inside each group. In this way, the time complexity is improved to O(mn²) or O(mN). If there are ten groups (m=10), the time cost is reduced by a factor of ten. Additional detail on the grouping of transition sets is provided below.

Block 306 builds a sensor relationship graph model and determines normal relationship ranges. The graph model is based on a multivariate Hawkes process. A Hawkes process is a multivariate point process model of mutually exciting processes that can be used to explain causal structure in data. The evolution of a multivariate Hawkes process depends on its entire history, and the process has a long memory property. This captures links between different sensor outputs. Additional details on the building the graph model are described below.

Block 308 evaluates the normal ranges for relationships and determines a threshold value for identifying anomalies. This process transfers validation data to groups of transition sets to calculate intensities of transition points. An anomaly score for each threshold is determined, so that an anomaly threshold can be generated. Additional details on the calculation of the anomaly threshold are described below.

The output of the model training process 300 includes the sensor relationship graph model and the anomaly threshold value. During training, sensor data is denoised 302 and transition sets are grouped 304. The relationship graph model is built for each transition group based on the multivariate Hawkes process approach. The transition set groups are applied to the trained Hawkes process models to evaluate a normal relationship range of each edge in the relationship graph models. Validation data is then used to calculate the threshold for the system-level anomaly score using the trained models.

During runtime, anomaly detection/prediction 310 is performed using the trained model(s) and the anomaly threshold. New data may be sampled from the sensors 104. As with the historical data, the newly sampled data may include both numerical data and categorical data, and the numerical data may be converted to categorical data by any appropriate process.

Block 312 generates transition set groups for the new data based on generated training transition set groups. Intensities may be determined for the transition points of each transition set in the groups. Block 314 then determines the anomaly score for each intensity, for example using the trained relationship graph models. The respective anomaly scores may be stored in an anomaly matrix.

Block 316 uses a sliding window to sample the anomaly score matrix, summing the anomaly scores in each window. If any summed anomaly score is larger than the threshold, then anomaly detection/prediction can generate an alert that an anomaly has been detected or predicted.

Based on the output of the anomaly detection/prediction 310, risk assessment 320 may be performed to determine what the appropriate response should be. For predicted anomalies, the risk assessment 320 may include a determination of how serious the consequences of the anomaly would be and a likelihood that the anomaly will occur. Block 330 may then trigger a responsive (or preventative) action relating to the detected or predicted anomaly.

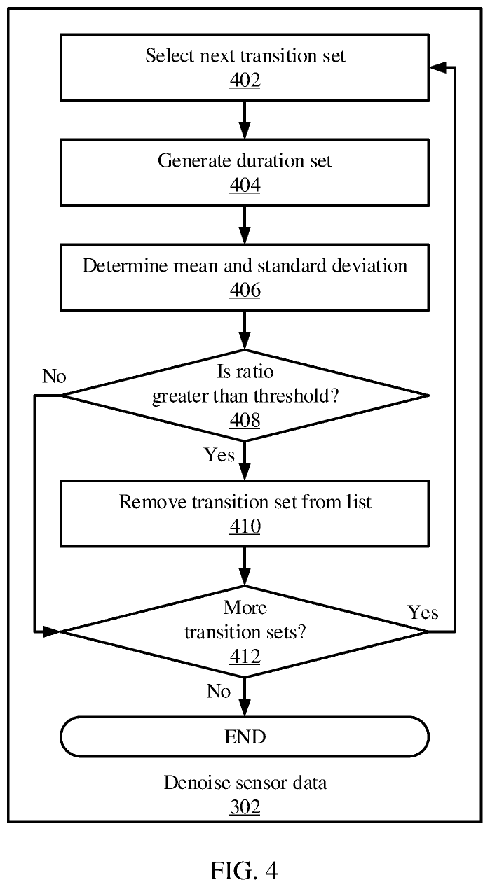

Referring now to FIG. 4, additional detail on denoising the sensor data 302 is shown. Block 402 selects a next transition set from a list of transition sets. Block 404 then generates a duration set for the source value of each transition point in the transition set. For example, if the transition set includes transitions from 0 to 1, then each duration may represent the amount of time that the sensor output stayed at 0 before the transition. Block 406 then determines the duration mean μ_{d} and standard deviation σ_{d} for these durations across the transition set.

Block 408 determines whether the ratio μ_{d}/σ_{d}, otherwise known as the coefficient of variation, is greater than a threshold value. The coefficient of variation is a measure of the stability of the durations for the transition set. If this value is large (e.g., greater than a variability threshold value), then the duration set of the selected unique value is not steady. In that case, block 410 removes the transition set from the list. Block 412 determines whether there are more transition sets to consider. If so, processing returns to block 402 where a next transition set is selected. If not, processing ends and the denoised data is output.

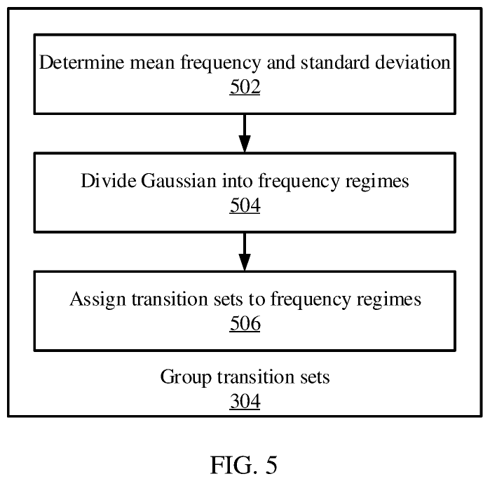

Referring now to FIG. 5, additional detail on grouping transition sets 304 is shown. Block 502 generates a list of the transition sets according to their frequencies. The number of elements in each transition set corresponds to how frequently the transition occurs, so that a transition set with a higher number of elements occurs more frequently than a transition set with a lower number of elements. These values may be used to determine a frequency mean μ_{f} and standard deviation σ_{f}.

A Gaussian distribution corresponding to μ_{f} and σ_{f} may be determined, and may be split into a low-frequency regime, a medium frequency regime, and a high-frequency regime in block 504. The medium frequency regime may be defined as a region around the frequency mean μ_{f} according to μ_{f}±βσ_{f}, where β is an appropriate constant value. Transition sets in this range are regarded as being in the medium frequency regime, while transition sets having a frequency greater than μ_{f}+βσ_{f} are regarded as being in the high frequency regime and transition sets having a frequency lower than μ_{f}−βσ_{f} are regarded as being in the low frequency regime. Block 506 assigns transition sets into regimes in this manner.

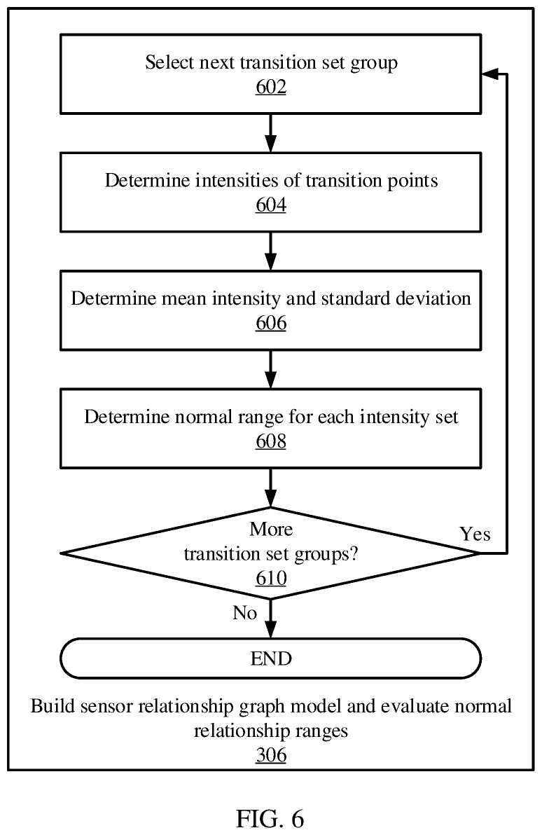

Referring now to FIG. 6, additional detail on building the sensor relationship graph models and evaluating normal relationship ranges 306 is shown. Block 602 selects a next transition set group (e.g., based on frequency regime) and block 604 determines the intensities of transition points for each transition set in the group. In particular, intensities may be determined as:

$${λ}_{i} ( t ) = {I}_{i} + {\sum }_{j = 1}^{D} {\sum }_{{t}_{k}^{j} < t} {ϕ}_{ij} ( t - {t}_{k}^{j} )$$

where D is the number of transition sets in the transition set group, Iᵢ are baseline intensities, ϕᵢⱼ are kernels of the Hawkes process model (ϕᵢⱼ=CR(Pᵢ, Pⱼ)e^{(-d(t}^{_{end}}^{-t}^{ₖ}^{^{j}}⁾), where tₖ^{j} are the timestamps of all transition points of transition set j, and i∈[1, . . . , D], c and d are coefficients determined in accordance with initial conditions and application. Block 606 determines a mean intensity μ_{I} and standard deviation σ_{I} for each intensity set in the group. Block 608 then determines a normal range for each intensity set, for example, defined as the range [μ_{I}−ασ_{I}, μ+ασ_{I}], where α is a constant value.

If block 610 determines that there is another transition set group to consider, processing returns to block 602 where a next transition set group is selected. If not, processing ends.

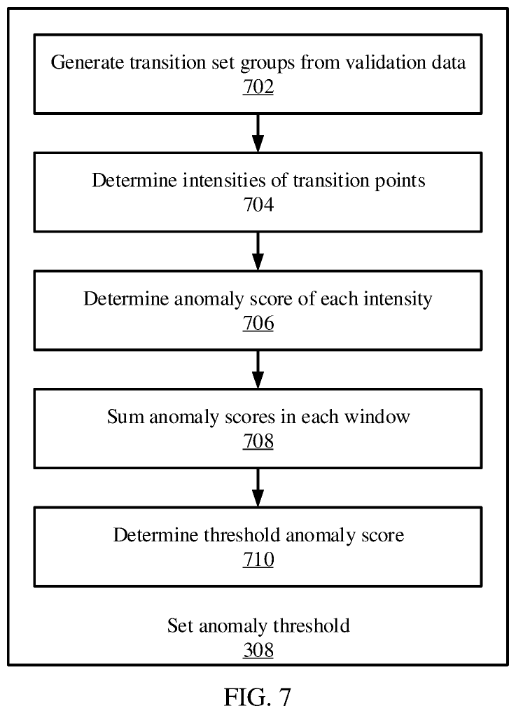

Referring now to FIG. 7, additional detail on setting the anomaly threshold 308 is shown. Block 702 generates transition set groups from a validation dataset, for example including historical data separate from that which is used to train the model. Block 704 determines intensities of transition points for each transition set in the groups, as described above with respect to building the sensor relationship graph model. Block 706 then determines an anomaly score of each intensity. The anomaly score may be determined as:

$$score = \{ \begin{matrix}0 , & if l \leq b \leq u \\ l - \frac{b}{l} , & if b < 1 \\ b - \frac{u}{u} , & if b > u\end{matrix}$$

where b represents a given intensity, r=[l, u] represents the normal range of b, with l being the lower bound and u being the upper bound.

Block 708 uses a sliding window to sample the anomaly scores, summing the anomaly scores in each window. Block 710 then determines a threshold for the system-level anomaly score based on the summed anomaly scores:

$$threshold = {μ}_{a} + {ρσ}_{a}$$

where μₐ is a mean of the summed anomaly scores, σₐ is the standard deviation of the summed anomaly scores, and ρ is a constant value.

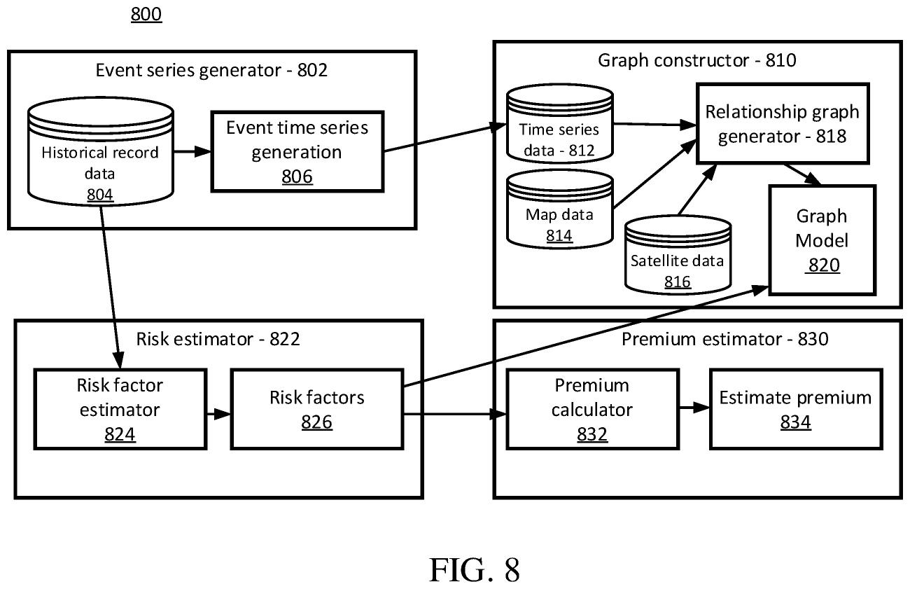

Referring to FIG. 8, insurance premium estimation can be based on sequential event modeling as described. Within the insurance industry, an important task revolves around the estimation of, e.g., premiums, contingent upon the myriad risk factors associated with a given region or circumstance. This undertaking poses a complex challenge, necessitating the analysis of multi-modal data encompassing, e.g., climate and weather data, spatial coordinates, historical house information, and more. Existing technologies in the insurance industry use rule-based systems for the analysis of real property premiums, focusing on isolated risk factors defined by domain experts. However, these systems face significant limitations in adaptability and scalability, particularly in the context of evolving risk landscapes such as climate change-induced natural disasters.

A Multivariate Hawkes Process based Insurance Estimation (MHPIE) tool 800 leverages a multivariate approach, integrating multi-modality data such as historical records, satellite images, and property-specific historical data to construct relationship graphs. By employing a sequential event model based on the Hawkes process, MHPIE autonomously identifies and evaluates risk factors associated with natural disasters and other occurrences. Moreover, the MHPIE tool offers seamless policy updates for all properties in response to new events, ensuring adaptability and effectiveness in risk management strategies.

The MHPIE tool 800 contributes to the efficient and effective estimations of insurance premiums. The MHPIE tool 800 provides applicability and feasibility by limiting parameter setting in advance (e.g., by default settings) and can be applied to a wide variety of insurances. The sensor relationship graph model described above can be used to both estimate the insurance premium and illustrate the details of premium cost in a visualized way to an end user. Public data is all that is needed as training input, private or sensitive data like the household income or owner races, ages can be avoided, if desired. Public data is more easily collected.

Embodiments of the present invention address the problem of insurance premium estimation by analyzing sequential events among multiple modality data. This can enable the insurance industry to estimate the premium more accurately and acquire new customers with low risk. The present embodiments are further adaptable to changing circumstances, for example as the relationships between identified properties change in response to environmental conditions.

The MHPIE tool can estimate the risk factors within the insurance industry from multi-modality data. By employing multi-modality data, systems and methods in accordance with the present embodiments, can take inputs of map data, satellite image data, historical record data, etc. The MHPIE tool 800 integrates these data as a relationship graph model. Note that MHPIE's flexibility permits effective operation even in the absence of certain data modalities, ensuring robust performance across varied scenarios. The MHPIE tool 800 employs graph models to predict the possibilities of occurrences, such as, e.g., natural disasters in a future period (risk factor prediction). Hence, an insurance company can adjust premiums based on predicted risk factors.

While privacy concerns are always at issue when using sensitive data, private data is not needed to implement the present embodiments. In some embodiments, the MHPIE tool 800 may employ only public and statistical data as training input. Sensitive and private data can be included based on permissions of its owners. The MHPIE tool 800 offers enhanced accessibility and utility, making it useful in insurance estimation practices.

In one illustrative embodiment, insurance premium estimation can be defined as follows: Input: Historical event data (e.g., natural disasters, etc.) and claim records (e.g., for real properties), map data and satellite image data (if any). Output: (1) A relationship graph model (e.g., for real properties), (2) The risk factors of each entity (e.g., real property owners), and (3) an estimated insurance premium.

An event series generator 802 reads the historical records 804 of occurrences (e.g., natural disasters). The historical records 804 can include claim records for a particular region or any other relevant data. The event series generator 802 generates event time series 806 for each entity, property or individual and stores this information in a time series database 812. This time series data may be expressed in the form of categorical information, for example by labeling categories identified within the input data or by converting numerical data to categorical data.

A relation graph generator or constructor 810 integrates map data 814, satellite image data 816 (and other data) and the event time series from database 812 into a relationship graph model 820 using a relationship graph generator 818.

A risk estimator 822 uses a risk factor estimator 824 that employs the Hawkes Point process described to estimate a probability of the occurrence or event happening in a certain future period. The risk factors can be output and/or stored in a risk factor database or storage 826.

A premium estimator 830 computes an insurance premium cost based on the estimated risk factors in the risk factor database 826. The estimated premiums can be output and/or stored in a premium database or storage 834. Other actions can include using the predictive capabilities to predict the weather, warn of storms, etc.

The MHPIE tool 800 may not be able to directly consume the historical records data 804 and documents. The historical records 804 may therefore to be converted into event time series 806 so that the tool can take it as input. This can be performed by assigning a tag to each type of event, e.g., “A” for a flood event, “B” for a hurricane event, “C” for wind damage, etc. For each entity (e.g., a house or property), a set of multi-dimensional event time series 812 is built up, with each time series relating to a specific event. For example in such a time series the x-axis may be interpreted as time and the y-axis may be interpreted as whether a given event was occurring at that time. For example, a value of 1 may indicate that the event (e.g., a rainstorm) occurred at the respective time, while a value of zero may indicate that the event did not occur. In this way, for each entity (house, in the example), a set of binary time series is generated.

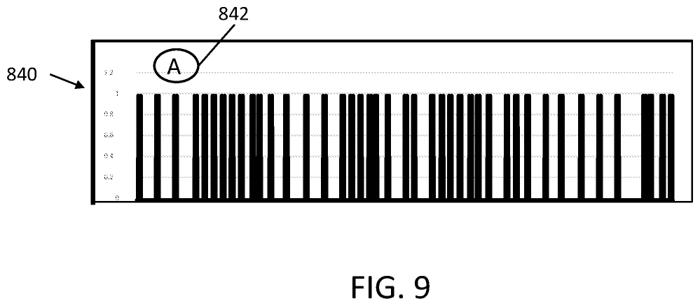

Referring to FIG. 9, an event time series 840 of a house is shown in accordance with an illustrative embodiment. Here, an event A 842 is defined as an encounter of heavy rain. From the time series, it can be seen that the house has frequently encountered heavy rain in the past few years. Such weather history data is easily collected from public databases.

Referring again to FIG. 8, the graph constructor 810 constructs a relationship graph 820 by treating each entity (e.g., real property) as a node and computing a relationship value between every pair of nodes. In one embodiment, there are three factors that make up the relationship value: a time series relationship, a road network distance on a map, and a grid distance on a satellite image. Other factors are also contemplated in addition to these or instead of these.

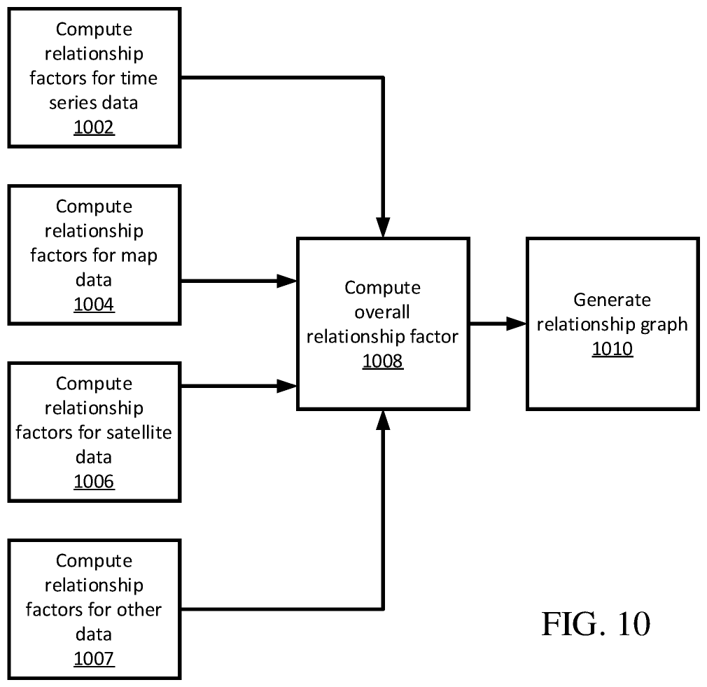

Referring to FIG. 10, a method for combining different data types is described. In block 1002, relationship factors are computed from time series data. The MHPIE tool 800 transfers historical records into the event time series. For example, there may be m event time series for each node, e.g., the time series of hurricane event, storm event, fire event, etc. Block 1002 determines relationships between a pair of, e.g., real properties based on these events.

Consider two time series shown in FIG. 2 as follows: time series A and time series B. The two time series track events over a same period of time. If a given event occurs in both time series at close timestamps, they may be considered to be related to each other. More formally, let e₁ be an event from time series A and e₂ be an event from time series B. Then, e₁ and e₂ are matched if: |t(e₁)−t(e₂)|<θₜ, where θₜ is a threshold of close time (to provide matched_pairs).

The relationship factor (Rₑ) of even time series can be computed as follows:

$${R}_{e} ( P 1 , P 2 ) = {\sum }_{i} \frac{2 * matched\_pairs ( {E}_{i} ( P 1 ) , {E}_{i} ( P 2 ) )}{\vert {E}_{i} ( P 1 ) \vert + \vert {E}_{i} ( P 2 ) \vert}$$

where P1, P2 are the two properties (nodes in the graph), Eᵢ(P1) and Eᵢ(P2) are the i^{th} event time series of the two properties. |Eᵢ(P1)| and |Eᵢ(P2)| are the total number of events in the time series. The overall relation factor is the sum of all the sub-factors from each time series.

In some embodiments, the relationship between two time series may instead be identified using a machine learning model. For example, correlations may be identified using a neural network that is trained in an unsupervised manner on a significant volume of historical data. Thus, even in contexts where events may not occur within the time threshold θₜ, there may nonetheless be behavior that is connected between different time series. As an example, the barometric pressure in a first location may correlate with precipitation in second location, even if the first location does not receive any rain.

In block 1004, relationship factors from the map data are computed. Another factor in relationship building is spatial location. In the example, for two real properties P1 and P2, the MHPIE tool 800 computes their distance on a road network (map), where the relationship factor of distance (Rₘ) can be computed by:

$${R}_{m} ( P 1 , P 2 ) = {e}^{- {net}_{dist ( P 1 , P 2 )}}$$

where the net_dist(P1, P2) is the distance of the road network between the two properties.

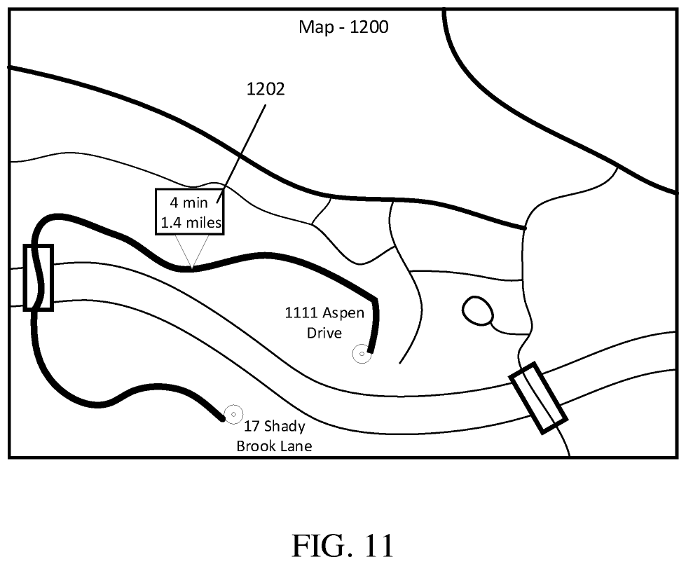

Referring to FIG. 11, an example map 1200 shows the distance between two real properties: 1111 Aspen Drive and 17 Shady Brook Lane. A distance 1202 between the two properties can be easily calculated with a public map service, e.g., Google® maps.

The two properties (1111 Aspen Drive and 17 Shady Brook Lane) are far from each other, they are both close to a river and have similar risks of flooding. The MHPIE tool 800 can also build a relationship based on satellite images.

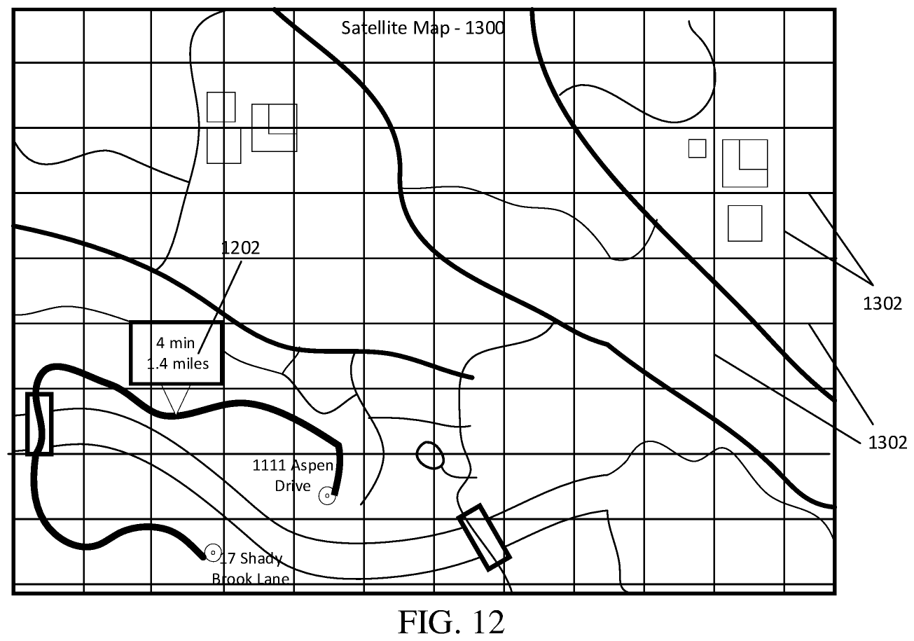

Referring to FIG. 12 with continued reference to FIG. 10, a relationship is computed from satellite data in block 1006. In addition to the network distance, the distance on a satellite image 1300 can also be important.

In the satellite image 1300 of FIG. 12, the MHPIE tool first partitions the image into grids 1302 with a fixed size. There is a coordinate for each grid. The distances between two properties (1111 Aspen Drive and 17 Shady Brook Lane) are computed based on a distance of the grids 1302 where they are located. The MHPIE tool 800 uses the grids 1302 to partition the image. For example, from the grid 1302 of 1111 Aspen Drive, it takes two grids spacings to reach the grid of 17 Shady Brook Lane, so that grid distance (grid_dist) between them is 2.

The MHPIE tool 800 computes the relationship factor (R_{g}) of distance as shown in following equation:

$${R}_{g} ( P 1 , P 2 ) = {e}^{- grid \_ dist ( P 1 , P 2 )}$$

In block 1008, an overall relationship factor is computed to generate a graph. After computing the sub-factors, MHPIE tool 800 computes the overall relationship factor as follows: R(P1, P2)=a*Rₑ(P1, P2)+b*Rₘ(P1, P2)+c*R_{g}(P1,P2) where a, b and c are three hyper-parameters that define relative weights for the contribution of each relationship value to the overall relationship. The hyper-parameters can be defined as 0.33 (e.g., specifying a mean, which may be the default value for three sub-factors), or may be adjusted by the end user based on their preference. It should be understood that while three sub-factors are described, any number of sub-factors can be incorporated into a model in accordance with the present embodiments, each sub-factor capturing a different type of data.

With the overall relationship factor computed, the MHPIE tool 800 generates a relationship graph in block 1010, as follows: (1) graph nodes are selected as entities, e.g., real properties in a certain region; (2) for each pair of entities, e.g., properties P1 and P2, the MHPIE tool 800 then computes the relationship R(P1, P2) between the pair. If the relationship score is larger than a threshold, an edge will be constructed between them; and (3) the MHPIE tool 800 outputs all the nodes and edges after checking all the pairs.

Referring again to FIG. 8, the risk estimator 824 can evaluate risk based on, e.g., a Hawkes process. With the relationship graph and historical event time series, the MHPIE tool 800 estimates a probability of an event happening in the future. This provides useful information and can have many practical applications. For example, an insurance company interested in risk factors of a type of disaster happening in certain time period T can use embodiments of the present invention to evaluate potential risk. In other applications, a failure event of a semiconductor device or other fabricated product can be evaluated. In still other embodiments, anomaly detection of computer modules or components can be determined. The length of period T can be chosen by the customer's preference, e.g., an insurance term, e.g., the next 20 years.

In an embodiment, the MHPIE tool 800 can employ an equation to compute the probability (Pro) of a specific event eₘ for property Pᵢ in a future period T:

$$Pro ( {P}_{i} , {e}_{m} , T ) = {u}_{i} + {\sum }_{j = 1}^{D} {\sum }_{{t}_{k}^{j} < t} c * R ( {P}_{i} , {P}_{j} ) * {e}^{- d * ( {t}_{end} - {t}_{k}^{j} )}$$

In the above equation, uᵢ is the base probability of event eₖ, e.g., how many times a hurricane hits a region in the past 20 years. D is the set of properties in the relationship graph. t is the current timestamp, and t_{end}=t+T, it is the end timestamp of the period T, e.g., 20 years later. tₖ^{j} are the timestamps of all the disaster events happening on property Pⱼ in the past. The kernel function of the Hawkes process model is defined as: c*R(Pᵢ,Pⱼ)*e^{-d*(t}^{_{end}}^{-t}^{ₖ}^{^{j}}⁾ where c and d are two constants (e.g., the default parameter can be employed) and where t_{end}−tₖ^{j} is the time length from the end timestamp to the timestamp of disaster ex happened on Pⱼ.

In one embodiment, the premium calculator 832 can estimate insurance premiums based on multiple risk factors. Suppose there are M different risk factors (types of disasters) in total, e.g., fire, storm, hurricane, earthquake, flood, etc. The final premium of property Pᵢ in term T is computed as follows:

$$Premium ( {P}_{i} , T ) = s * {\sum }_{m = 1}^{M} Pro ( {P}_{i} , {e}_{m} , T ) * Damage ( {e}_{m} ) * Value ( {P}_{i} )$$

where Value(Pᵢ) is the value of the property, Damage(eₘ) is the estimated damage that disaster event eₘ can cause, e.g., the hurricane can cause a 50% damage to the value of the entire property, and a fire may cause 100% damage to the property value. Therefore, the total loss of property Pᵢ in the future term T, is calculated as Σₘ₌₁^{M} Pro(Pᵢ, eₘ, T)*Damage(eₘ)*Value(Pᵢ). The parameter “s” is the profit factor, where for example s=1.2 means the company may charge 20% more than the possible loss on this property.

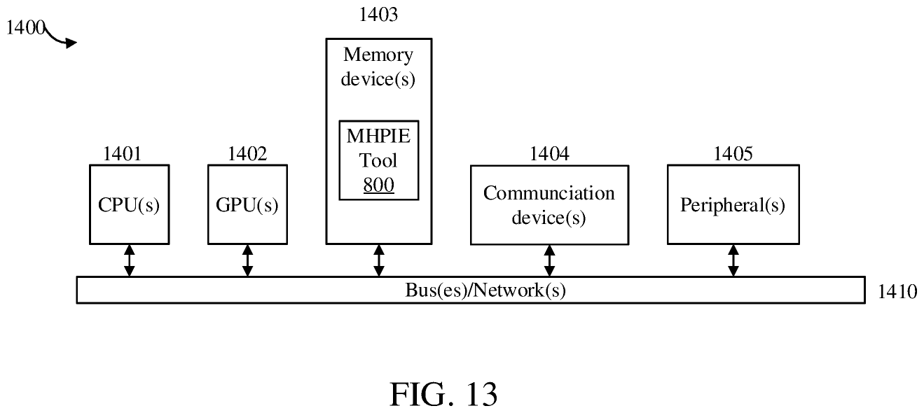

Referring to FIG. 13, a block diagram is shown for an exemplary processing system 1400, in accordance with an embodiment of the present invention. The processing system 1400 includes a set of processing units (e.g., CPUs) 1401, a set of GPUs 1402, a set of memory devices 1403, a set of communication devices 1404, and set of peripherals 1405. The CPUs 1401 can be single or multi-core CPUs. The GPUs 1402 can be single or multi-core GPUs. The one or more memory devices 1403 can include caches, RAMs, ROMs, and other memories (flash, optical, magnetic, etc.). The communication devices 1404 can include wireless and/or wired communication devices (e.g., network (e.g., WIFI, etc.) adapters, etc.). The peripherals 1405 can include a display device, a user input device, a printer, an imaging device, and so forth. Elements of processing system 1400 are connected by one or more buses or networks (collectively denoted by the figure reference numeral 1410).

In an embodiment, memory devices 1403 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 1403 store program code for implementing one or more functions of the MHPIE tool 800. In one embodiment, memory devices 1403 store program code for event series generation, relation graph generation, risk factor estimation and conducting actions responsive to these and other inputs (e.g., anomaly detection, insurance premium estimation, failure prediction, etc.).

Of course, the processing system 1400 may also include other elements (not shown), as readily contemplated by one of skill in the art, as well as omitting certain elements. For example, various other input devices and/or output devices can be included in processing system 1400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 1400 are readily contemplated by one of ordinary skill in the art given the teachings of the present invention provided herein.

Moreover, it is to be appreciated that various figures as described below with respect to various elements and steps relating to the present invention that may be implemented, in whole or in part, by one or more of the elements of system 1400.

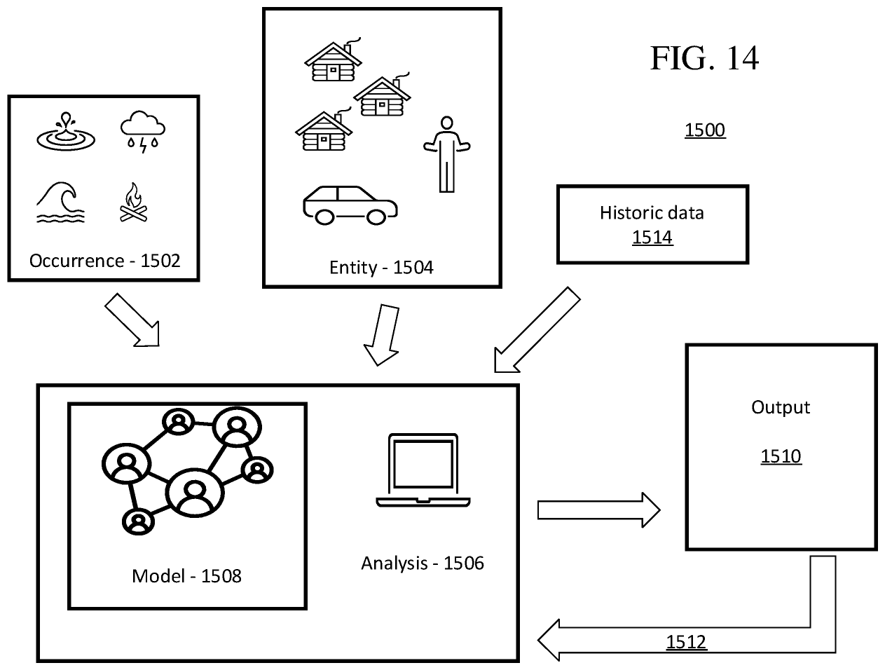

Referring to FIG. 14, a block/flow diagram shows a dynamic system/method 1500 which constantly updates a model 1508 in accordance with new and updated event or occurrence information. Occurrences 1502, such as natural events (e.g., disasters, weather, forest fires, floods, etc.), human events (e.g., war, crimes, etc.), human specific events, (e.g., a new baby, marriage, etc.), driving data and any other relevant time series data can be input to the model 1508. The occurrence information can include categorical, numerical or other data types and can be combined to include a uniform data format. Historical data 1514 can also be transformed into a common data format and incorporated into the dynamically updated model 1508. Based on the information provided and updates within a given time frame and entity information 1504 input to one or more analysis computer systems 1506, the data is analyzed to make predictions. Entity information 1504 can include real property information, automobile information, product information, personal information (e.g., insured individual data, etc.). The predictions can be employed for any number of practical applications (e.g., anomaly detection, insurance premium estimation, failure prediction, etc.).

In one example, predictions are employed to evaluate whether a home will be subjected to natural disasters in the near future, and if so are larger insurance premiums warranted. Other examples can include whether a mechanical device will fail or any other predictive assessment. An output 1510 can include new premiums, detected anomalies, detected failures, warning signals, etc.

The system/method 1500 can be updated periodically or continuously depending on the applications using a feedback loop 1512. In this way, the model 1508 can be updated to reflect the most accurate information within an update time cycle. The update time cycle can permit continuous update with new information or be updated in accordance with a set time interval, e.g., days, months or years.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for event prediction, comprising:
converting event information into categorical time series data for a plurality of properties;
determining relationships between pairs of properties of the plurality of properties based on a plurality of data types;
predicting a likelihood of an event occurring during a future period by summing over a Hawkes process for the pairs of properties, the Hawkes process taking as input the relationships between the pairs of properties;
comparing the likelihood to an anomaly threshold that is based on a range of normal intensity values for transition sets based on the categorical time series data; and
performing an action responsive to a determination that the likelihood exceeds the anomaly threshold.

2. The method of claim 1, wherein converting the event information into categorical time series data includes mapping numerical values onto categorical values.

3. The method of claim 1, further comprising de-noising the categorical time series data by determining a mean duration and standard deviation for an initial state of each transition set to calculate a coefficient of variation and removing transition sets with a coefficient of variation that is above a threshold value.

4. The method of claim 1, wherein the plurality of data types include a relationship value based on a correlation of categorical time series data for a pair of properties.

5. The method of claim 4, wherein the plurality of data types further include a grid distance between locations associated with the pair of properties.

6. The method of claim 4, wherein the plurality of data types further include a road network distance between locations associated with the pair of properties.

7. The method of claim 4, further comprising determining the correlation of categorical time series data for the pair of properties using a neural network model.

8. The method of claim 4, further comprising determining the correlation of categorical time series data for the pair of nodes based on an occurrence of events in the time series data within a threshold time.

9. The method of claim 1, wherein the anomaly relates to a likelihood of a natural disaster occurring at a particular location, such that a likelihood output of the Hawkes process that exceeds the anomaly indicates that the natural disaster is likely to occur at the location.

10. The method of claim 1, wherein the action includes adjusting an insurance premium associated with a property of the plurality of properties in accordance with the anomaly.

11. A system for event prediction, comprising:
a hardware processor; and
a memory that stores a computer program which, when executed by the hardware processor, causes the hardware processor to:
convert event information into categorical time series data for a plurality of properties;
determine relationships between pairs of properties of the plurality of properties based on a plurality of data types;
predict a likelihood of an event occurring during a future period by summing over a Hawkes process for the pairs of properties, the Hawkes process taking as input the relationships between the pairs of properties;
compare the likelihood to an anomaly threshold that is based on a range of normal intensity values for transition sets based on the categorical time series data; and
perform an action responsive to a determination that the likelihood exceeds the anomaly threshold.

12. The system of claim 11, wherein the computer program further causes the hardware processor to map numerical values onto categorical values.

13. The system of claim 11, wherein the computer program further causes the hardware processor to de-noise the categorical time series data by determining a mean duration and standard deviation for an initial state of each transition set to calculate a coefficient of variation and removing transition sets with a coefficient of variation that is above a threshold value.

14. The system of claim 11, wherein the plurality of data types include a relationship value based on a correlation of categorical time series data for a pair of properties.

15. The system of claim 14, wherein the plurality of data types further include a grid distance between locations associated with the pair of properties.

16. The system of claim 14, wherein the plurality of data types further include a road network distance between locations associated with the pair of properties.

17. The system of claim 14, wherein the computer program further causes the hardware processor to determine the correlation of categorical time series data for the pair of properties using a neural network model.

18. The system of claim 14, wherein the computer program further causes the hardware processor to determine the correlation of categorical time series data for the pair of nodes based on an occurrence of events in the time series data within a threshold time.

19. The system of claim 11, wherein the anomaly relates to a likelihood of a natural disaster occurring at a particular location, such that a likelihood output of the Hawkes process that exceeds the anomaly indicates that the natural disaster is likely to occur at the location, and wherein the computer program further causes the hardware processor to adjust an insurance premium associated with a property of the plurality of properties in accordance with the anomaly.

20. A computer program product for event modeling, the computer program product comprising a computer readable storage medium having program instructions embodied therewith, the program instructions executable by a hardware processor to cause the hardware processor to:
convert event information into categorical time series data for a plurality of properties;
determine relationships between pairs of properties of the plurality of properties based on a plurality of data types;
predict a likelihood of an event occurring during a future period by summing over a Hawkes process for the pairs of properties, the Hawkes process taking as input the relationships between the pairs of properties;
compare the likelihood to an anomaly threshold that is based on a range of normal intensity values for transition sets based on the categorical time series data; and
perform an action responsive to a determination that the likelihood exceeds the anomaly threshold.
